(19) United States
(12) Patent Application Publication
(10) Pub. No.: US 2015/0125610 A1
(43) Pub. Date: May 7, 2015

(54) PROCESS AND SEAL TREATMENT FOR IMPROVING CORROSION RESISTANCE AND PAINT ADHESION OF METAL SURFACES

(71) Applicant: Bulk Chemicals, Inc., Reading, PA (US)

(72) Inventor: Richard J. Church, Myerstown, PA (US)

(73) Assignee: Bulk Chemicals, Inc., Reading, PA (US)

(21) Appl. No.: 14/069,995

(22) Filed: Nov. 1, 2013

(51) Int. Cl. C09D 5/08

(52) U.S. Cl. CPC C09D 5/08
USPC 427/318; 106/14.11; 106/14.15; 106/14.13; 427/327

(57) ABSTRACT

Aqueous seal coat compositions useful for sealing a pretreated metal surface, comprise water, at least two organo-functional silanes, and optionally a pH-adjusting agent. A process for sealing a pretreated metal surface includes contacting the metal surface with such an aqueous seal coat composition. Preferably, the pH of the seal coat compositions is greater than 5.5.

### FIELD OF THE INVENTION

This invention relates to compositions and the use of such compositions for improving the corrosion resistance and paint adhesion of metal surfaces. The composition of the invention may be used as a seal treatment of a paint pre-treatment process and is intended to be used to treat a range of metals including alloys of aluminum, copper, magnesium, and iron, and most preferably aluminum alloys.

### BACKGROUND OF THE INVENTION

The steps and constituents used to treat metal surfaces are critical to enhance the paint adhesion and corrosion resistance of metal surfaces, and thus the life of metal surfaces. In general, there are typically three stages involved in pre-treating metal surfaces: cleaning; applying a conversion coating; and applying a final seal treatment or seal coating. The cleaning stage removes dirt, debris, and oils from the metal surface to ensure that subsequent coatings are evenly and completely applied on the metal surface. A thorough cleaning stage minimizes the presence of such dirt, debris, and oils, which could later become sites for corrosion and peeling paint. The application of the conversion coating provides a layer on the metal surface formed by the reaction of the conversion coating with the metal surface. The layer formed by the application of a conversion coating improves the corrosion resistance and paint adhesion of the metal surface. Final seal treatments or coatings further enhance the corrosion resistance and paint adhesion of the metal surface, thus improving the effectiveness of the conversion coating and the overall pretreatment process. A decorative coating or paint may then be applied to the metal surface, such as conventional, electrocoat and powder-based paints or decorative coatings.

One of the more rigorous requirements for corrosion resistance and paint adhesion qualities is in the aerospace industry. For obvious safety concerns, it is desirable to meet challenging specifications for a pre-treatment system to be permitted to be used in the aerospace industry. The military specification, MIL DTL-81706B, covers chemical conversion materials used in the formation of coatings by the reaction of the material with the surfaces of aluminum and aluminum alloys. This specification provides a rigorous standard of ratings in the following tests: Wet tape adhesion, salt spray exposure, and surface resistivity, before and after salt spray exposure.

### SUMMARY OF THE INVENTION

A seal coat composition has now been discovered that improves the paint adhesion and corrosion resistance of metal surfaces. Embodiments of the invention meet or exceed the performance characteristics of military specification, MIL DTL-81706B, without having any hexavalent chromium in the pre-treatment system. The compositions of the present invention may be used for passivating and improving the paint adhesion of metal surfaces. The invention may be used as a pre-paint treatment for a range of metals including alloys of copper, brass, magnesium, aluminum, and iron, especially aluminum and aluminum alloys and most preferably high copper aluminum alloys. Additionally, it has now been found that the mild acidity or alkalinity of the compositions of the present invention improves paint adhesion and corrosion resistance.

The present invention relates to an aqueous seal coat composition for sealing a pretreated metal surface to passivate the surface, improve paint adhesion, and/or improve corrosion resistance. In one embodiment, the seal coat comprises water and at least two organo-functional silanes, wherein the composition has a pH>5.5. In another embodiment, the pH of the aqueous sealing composition is in the range of greater than 6 and may range from about 6 to about 10, preferably from about 7 to about 9.

In yet another embodiment, the present invention is a process for treating a metal surface which includes the steps of cleaning the metal surface; contacting the metal surface with an aqueous pretreatment composition comprising water and a compound of a Group IV-B element; and contacting the metal surface with an aqueous sealing composition for sealing a pretreated metal surface comprising water and at least two organo-functional silanes, wherein the composition has a pH>5.5.

In still another embodiment, the present invention relates to an aqueous sealing composition consisting essentially of water, at least two organo-functional silanes, and a pH-adjusting agent, wherein the composition has a pH>5.5

### DETAILED DESCRIPTION OF THE INVENTION

The present invention is directed to compositions and methods for treating metal surfaces to improve paint adhesion and corrosion resistance, and preferably applied as a seal coat in a pretreatment process. Compositions according to the present invention comprise water, at least two organo-functional silanes, and optionally a pH-adjusting agent, wherein the composition has a pH of greater than 5.5, preferably greater than 6, and more preferably greater than 6.5. Processes according to the present invention include contacting the metal surface with an aqueous pretreatment composition comprising water, at least two organo-functional silanes, and optionally a pH-adjusting agent, wherein the composition has a pH of greater than 5.5, preferably greater than 6, and more preferably greater than 6.5.

The present invention provides compositions and processes for treating metal, which are environmentally-friendly, while still maintaining excellent paint adhesion and corrosion resistance. Furthermore, the mildly acidic or alkaline pH of the compositions of the present invention has been found to improve the efficacy of a silane as a seal coat to improve paint adhesion, corrosion resistance, and surface resistivity, as specified in military specification MIL DTL-81706B. In one embodiment, the pH of the composition is between about 5.5 and about 10. In another embodiment, the pH of the composition is between 7 and 9.

As used herein, the terms “pretreatment composition” (or “conversion coating”) and “seal coat” (or “final seal”) mean compositions which, when applied sequentially, improve the paint adhesion and corrosion resistance of a metal surface. Aqueous pretreatment compositions and sealing coats of the present invention are used in a pretreatment process prior to painting or may be used as a passivation treatment to reduce the formation of rust in the uncoated (unpainted) condition. Thus, while the compositions are referred to herein as a pretreatment composition or a sealing composition for convenience, these compositions are used for pretreatment (i.e., improving the adhesion of subsequently applied paint) or passivation (i.e., resisting corrosion of the unpainted surface).

As used herein, the term “treating” shall mean any and all steps up to and including painting a metal surface. In one embodiment, the treating process includes applying a pre-treatment, or cleaning, rinsing, and applying a pre-treatment of the present invention and optionally also applying a seal coat. Treatment steps may also include a step of applying a decorative coating, such as painting by electrocoating. After applying the pretreatment, the pretreatment may be rinsed first or dried-in-place before application of the paint. Each of these steps above play a role in a final product's ability to resist corrosion and minimize paint loss, as is well-known in the art. In one embodiment, the treatment process includes the steps of cleaning; rinsing with water; applying a pretreatment; rinsing with water; applying a seal coat composition according to the present invention; and drying. The treating process may further comprise painting the so-treated and dried metal surface.

As used herein, the term “metal,” used for example in the phrase “metal surface,” includes aluminum, iron, zinc, and combinations thereof. Each metal listed includes both the elemental metal and alloys thereof; for example, the term “aluminum” means aluminum and aluminum alloys. The term “alloy” is a metal in which the primary metal has the highest content of every other element or a content equal to the highest content of every other element, e.g. an aluminum alloy being a metal in which aluminum is present in an amount at least equal to that of any other element. Iron alloys include cold rolled steel, electro-galvanized steel, and hot-dipped galvanized steel. Preferably, compositions of the present invention are used to treat a range of metals including alloys of copper, brass, magnesium, chrome, tin, aluminum, and iron, especially aluminum and aluminum alloys and most preferably high copper aluminum alloys.

As used herein, the term “silane” has the same meaning as defined in U.S. Pat. No. 5,393,353 to Bishop, which is incorporated herein by reference. In addition, the term “organo-functional silane” has the same meaning as defined in U.S. Pat. No. 6,126,997 to Rivera et al., also incorporated herein by reference. Specifically, the term “organo-functional silane” means a compound having: (1) a silane radical (e.g., silyl (—SiH₃), disilanyl (—Si₂H₅), etc.); (2) an organic group (such as an alkyl, an aryl or an alkoxy group); and (3) a functional group. Such functional groups include, but are not limited to, amino, epoxy, methoxy, vinyl, and mercapto groups. Exemplary organo-functional silanes that can be used according to the present invention include aminopropyltriethoxy silanes, mercapto silanes, and epoxy silanes. Without being bound to any theory, it is believed that the organo-functional silane serves to bond with, or assist in bonding among, either the other constituents in the treatment composition or the constituents of other compositions or the metal surface itself or some combination thereof.

Various silanes may be suitably employed by the present invention. As discussed, the seal coat comprises at least two organo-functional silanes. In some embodiments of the invention, the at least two organo-functional silanes are selected from the group consisting of epoxy functional silane (e.g., gamma-glycidoxypropyltrimethoxy silane), aminopropyltriethoxy silane, and aminoethylaminopropyltrimethoxy silane. In some embodiments, the at least two organo-functional silanes comprise at least one epoxy functional silane and at least one amino functional silane, such as aminopropyltriethoxy silane. An exemplary aminopropyltriethoxy silane may be that which is sold under the trade name AMEO by Degussa AG of Dusseldorf, Germany, or under the trade name Silwet® A-1100 by Crompton Corporation of Greenwich, Conn.

As used herein, the term “compound of a group IV-B element” means an acid and/or a salt of a group IV-B element, as described in U.S. Pat. No. 5,859,106 to Jones et al., incorporated herein by reference. Such acids include fluorozirconic acid (H₂ZrF₆), fluorotitanic acid (H₂TiF₆), and fluorohafnic acid (H₂HfF₆). An exemplary salt of a Group IV-B element is ammonium zirconium carbonate. Without wishing to be bound by any particular theory or explanation, it appears that the group IV-B element, such as zirconium, increases the interaction between the composition and the metal surface, in effect helping to bond the composition to the metal surface. The aqueous pretreatment composition preferably includes a source of trivalent chromium, which might either be part of the compound of the group IV-B element itself or could be a chromium salt, such as chromium sulfate. Preferably, the pre-treatment comprises a pre-treatment described in U.S. Pat. No. 8,425,692, incorporated herein by reference, such as chromium fluozirconate made according to Examples 2 or 4 in the '692 patent.

In one embodiment, the seal coat composition comprises, consists essentially of, or consists of water, at least two organo-functional silanes, and an optional pH-adjusting agent, wherein the composition has a pH of at least 5.5. The at least two organo-functional silanes preferably are an epoxy functional silane and an aminopropyltriethoxy silane. The concentration of the epoxy functional silane may be 0.05% weight/vol. or greater, and preferably between about 0.05% and 0.40% weight/vol. and more preferably between about 0.10% and 0.30% weight/vol. The concentration of the aminopropyltriethoxy silane may be 0.05% weight/vol. or greater, and preferably between about 0.05% and 0.40% weight/vol. and more preferably between about 0.10% and 0.30% weight/vol. Furthermore, the composition may contain the epoxy functional silane at a concentration of 0.1% weight/vol. or greater and aminopropyltriethoxy silane at a concentration of 0.1% weight/vol. or greater. Alternatively, the concentration of epoxy functional silane may be at least 0.08% and the concentration of the aminopropyltriethoxy silane may be at least 0.2% weight/vol. A person of ordinary skill would recognize that the invention encompasses a variety of concentrations.

The pH of the seal coat of the present invention can vary over a wide range, as mentioned above. The pH of the compositions of the present invention are in the mildly acidic or alkaline range of pH greater than 5.5, preferably greater than about 6, 6.5, or even 7 and preferably less than 10, and more preferably less than 9. Specifically, the pH of the composition may be in the range of about 5.5 to about 10, and more preferably in the range of about 6 to about 10, and more preferably about 6.5 to 9. The pH of the compositions of the present invention aids in the stability of the compositions. It also promotes adherence to the metal surface, enhancing the surface coating characteristics of the treatment. The pH-adjusting agent may be any known compatible acid or base, and preferably is formic acid. Other acids, including other small molecule acids with similar acidity, such as lactic acid, may be used

The concentrations of the constituents of the present invention, as well as the application temperature and residence time, can vary over a wide range and can be modified in a known manner, depending on the desired coating weight. In addition, the desired coating weight will be a function of the type of metal, the timing of processing after application of the pretreatment, the environmental conditions to which the treated metal is exposed, and the type of decorative coating used, among other factors. The coating process can be effected by employing any of the coating techniques known in the art. Contact can be effected by spray, immersion or flow coating techniques. The amount of coating should be sufficient to achieve the desired characteristics of the dried metal for its intended use.

Component concentrations of a working bath of the present metal pretreatment and seal coat can vary over a wide range. Appropriate concentration ranges of the various components are primarily dependent upon their solubilities, as is known in the art. Above the solubility limits, the solute may begin to come out of the solution. At concentrations too low, there is insufficient amounts of the constituents to achieve the desired coating weight in a reasonable time and to perform their functions. Formulating compositions according to the invention in light of these constraints is well within the ability of the person of normal skill in the art. Additionally, while these compositions may be provided as a concentrate, they are generally utilized as a dilution with distilled water.

Treatment of metal surfaces according to the invention typically includes contacting the metal surface with an aqueous final seal composition comprising water, at least two organo-functional silanes, and the optional pH-adjusting agent. The process may further include the steps of, before the contacting step, contacting the metal surface with an aqueous composition comprising a pretreatment composition, and then contacting the metal surface with the aqueous final seal composition. The process may additionally include cleaning the metal surface. The process may further include, after contacting the metal surface with the aqueous pretreatment composition, the steps of rinsing the metal surface with water, then contacting with the seal coat of the present invention, drying, then painting the surface of the metal. Alternatively, the pretreatment composition may be dried-in-place (i.e., not rinsed), then sealed and painted.

Contacting of the metal surface may be performed by any known coating technique, including for example spraying, immersing, roll coating, or flow coating. Optionally, after contacting the rinsed metal surface with a final seal coat composition, the metal surface is dried and then a decorative coating (e.g. painting) is applied, without rinsing between these steps.

The cleaning step reduces oil and other contaminants from the surface of the metal, and is typically effected by immersing the metal surface in a bath of an alkaline or acid cleaning solution to form a cleaned metal surface. The cleaning solution may be an aqueous solution of a silicated alkaline cleaning agent. Such a silicated alkaline cleaning solution is sold by Bulk Chemicals Inc., Reading, Pa., under the brand name Bulk Kleen. Some exemplary silicated alkaline cleaning agents which can be used according to the present invention include sodium carbonate, sodium hydroxide, and potassium hydroxide. Alternatively, the cleaning step may be carried out by an acidic composition. Other means of cleaning may also be used in addition to, or instead of, silicated alkaline cleaning baths. In some cases, cleaning may not be required at all, and this step may be omitted.

A metal surface which has been contacted by a cleaning solution is referred to herein as a “cleaned metal surface.” It is cleaned in the sense it has been exposed to the cleaning solution. It is not completely free of contaminants, however, inasmuch as vestiges of the bath and other impurities may remain. Only after it is rinsed with water can it be viewed as fully cleaned and ready to make contact with a pretreatment composition (i.e., substantially all of the impurities are, by that point, removed). The rinsing step is a conventional water rinsing step, preferably using deionized water, to remove any excess cleaner or detergent left on the metal surface from the cleaning step. The use of deionized water avoids the introduction of any deleterious ions, such as chloride ions, into the system. After the metal surface is rinsed, it is treated with an aqueous composition of the sort described above according to the invention.

In an embodiment of the invention, the process includes, after cleaning, contacting the metal surface with an aqueous pretreatment composition comprising water and a compound of a Group IV-B element. In a preferred embodiment, the compound of a group IV-B element comprises chromium fluozirconate. In another, the compound of a group IV-B element comprises a fluo acid, such as fluozirconate, and the pretreatment further comprises a trivalent chromium salt, such as chromium fluoride. The concentrations of the constituents of the pretreatment composition may vary over a wide range, for example Cr: 50 to 300 ppm and Zr:130 to 800 ppm, and preferably Cr:60 to 150 ppm and Zr: 250 to 400 ppm.

The pretreatment may be applied in any number of known ways. One well-known coating technique is reverse roll coating, whereby a sheet of metal is pulled between counter-rotating cylinders, which are rotating against the direction of travel of the sheet being unrolled. The solution is rolled down along these cylinders until it contacts the metal. As the sheet metal is passed between the cylinders in a direction against the direction of rotation of the cylinders, some wiping force is applied to the metal. Another conventional method is known as the quick-dip method, whereby sheet metal is dipped into a batch containing the coating composition and is subsequently passed between two rolls to remove the excess. As will be appreciated by one of normal skill in the art, the concentration, temperature, and pH of the bath are interrelated.

After pretreatment, the metal is preferably then dried (e.g., by blown air or by an oven). The temperatures for the drying operation may range from about 60° F. to about 500° F. The length of the drying step will depend upon the temperature utilized. In addition, air may be blown over the metal to enhance the evaporation.

The desirable performance characteristics of the present invention can be achieved by the processing steps described above to produce a pretreated metal surface with good paint adhesion and corrosion resistance. These characteristics are obtained on the metal surface without a decorative coating. Accordingly, the treated metal surface can be used as unpainted products and will exhibit corrosion resistance even if there is a delay between the treatment steps and any subsequent painting.

A decorative paint coating may be applied to the dried metal surface. Typical non-limiting examples of decorative coatings include paints and lacquers, including electrocoated paints. Suitable paints are available from a number of vendors. A top coat may be applied to the treated metal surface, either as a treated surface or as a treated and painted surface. For example, a suitable polyester triglycidyl isocyanurate (TGIC) powder coating top coat is sold by DuPont of Wilmington, Del., under the tradename Alesta® AR.

In sum, the present invention provides environmentally friendly compositions and processes for treating metal, while still maintaining excellent paint adhesion, corrosion resistance, and surface resistivity. More particularly, the present invention avoids the use of hexavalent chromium and its associated health hazards and disposal problems

### EXAMPLES

The following examples are included to more clearly demonstrate the overall nature of the present invention. Examples 1-9 illustrate the results obtained by employing aqueous compositions of this invention.

### Example 1

Example 1 provides the results of samples treated with various formulations according to the various embodiments of the present invention. These samples were tested under a standard salt spray test for 336 hours in accordance with ASTM B117. All salt spray performance ratings (pass/fail) in all of the examples were carried out in accordance with MIL-DTL-81706B. The tests were performed on bare 2024 T3 aluminum panels. In all examples, the panels were not painted with the exception of the Wet Tape Adhesion test panels in Example 6. These had a primer applied over the pretreatment.

The tests panels were prepared by the following process prior to testing. All of the test panels were cleaned for five minutes with a silicated alkaline cleaner (Bulk Kleen™ 737G). The alkaline cleaner was prepared at a concentration of 15 g/L and heated to 140° F. Panels were rinsed with non-deionized water for one minute and then rinsed with deionized water for one minute. A conversion coat (or pretreatment) of an aqueous solution of Cr₂(ZrF₆)₃ in deionized water was applied to the panels for three minutes. In particular, and unless otherwise noted in these examples, the conversion coat was a solution of Cr₂(ZrF₆)₃ in DI water, with a Cr concentration of 120 ppm and a Zr concentration of 317 ppm. The conversion coat was adjusted to a pH value of 4 using ammonium carbonate. The panels were then rinsed using deionized water for thirty seconds. A seal coat in accordance with an embodiment of the present invention was applied for thirty to forty-five seconds. All panels in all of the examples were processed by immersion. The panels were then dried at 210-220° F. for five minutes.

The column that reads “Deoxidize Prior to Conversion Coat?” in Table 1 indicates whether the sample was deoxidized prior to application of the conversion coating or pretreatment. As is apparent from the table below, sample 8 is the only panel in the table that was deoxidized and shows the detrimental effects of deoxidizing. A deoxidizer commercially available from assignee of this application, Bulk Dox™, was applied at 100C @ 10%, ambient, for 1 min between steps 2 and 3 of the standard process when preparing Sample 8. The silane seal was also applied to sample 8 after conversion coating and rinsing.

In all of the examples, the panels listed as “Control” were cleaned with a silicated cleaner, rinsed with tap water, rinsed with DI water, given a conversion coating in the Cr₂(ZrF₆) bath, rinsed with DI water, and dried. No silane seal was applied to the controls.

In this example, the sealants contained water, A-187 (an epoxy functional silane sold under the trademark Silquest® A-187, gamma-glycidoxypropyltrimethoxysilane, available from Momentive Performance Materials, Inc.), and A-1100 (an aminopropyltriethoxy silane sold under the trademark Silwet® A-1100 by Crompton Corporation of Greenwich, Conn.). All percentages are provided in weight/volume percent. Sample 10 also included “Zonyl FSN,” which is an ethoxylated, nonionic fluorosurfactant available from DuPont. Unless the pH is indicated as “unadjusted,” the pH of the seal coat was adjusted with formic acid. The sealants' formulas and the results of the test are listed below in Table 1:

TABLE 1

| | | | Deoxidize | | | Standard |
|---|---|---|---|---|---|---|
| | A- | A- | Prior to | Zonyl | | 336 hour |
| | 187 | 1100 | Conversion | FSN | | Salt Spray |
| Sample | (%) | (%) | Coat? | (%) | pH | test |
| 1 | 0.2 | 0.2 | No | | 10 | Pass |
| | | | | | (unadjusted) | |
| 2 | 0.2 | 0.2 | No | | 5.2 | Fail |
| 3 | 0.4 | 0.2 | No | | 5.2 | Fail |
| 4 | 0.2 | 0.2 | No | | 9.9 | Pass |
| 5 | 0.2 | 0.2 | No | | 9.0 | Pass |
| 6 | 0.2 | 0.2 | No | | 8.3 | Pass |
| 7 | 0.2 | 0.2 | No | | 6.5 | Pass |
| 8 | 0.2 | 0.2 | Yes | | Unadjusted | Fail |
| 9 | 0.4 | 0.4 | No | | 9.0 | Pass |
| 10 | 0.4 | 0.4 | No | 0.01 | 9.0 | Pass |
| 11 | | | No | | n/a | Fail |
| (Control) | | | | | | |

Table 1 shows that the embodiments described herein provide substantial corrosion resistance. More specifically, the results show that various concentration levels and pH levels can successfully provide corrosion resistance under a 336 hours standard salt spray test. Notably, the results reveal that at a pH of 5.2, the embodiments containing 0.2% A-187 and 0.2 or 0.4% A-1100 did not provide adequate corrosion resistance. The results, however, revealed that compositions at a pH of 6.5 or above passed the salt spray test in accordance with MIL-DTL-81706B.

### Example 2

Example 2 provides the results of samples treated with various formulations according to various embodiments of the present invention. These samples were tested under a standard salt spray test for 336 hours and rated in accordance with MIL-DTL-81706B. The tests were performed on bare 2024 T3 aluminum panels.

The tests panels were prepared by the following process prior to testing. All of the test panels were cleaned for five minutes with a silicated alkaline cleaner (Bulk Kleen™ 737G). The alkaline cleaner was prepared at a concentration of 15 g/L and heated to 140° F. Panels were rinsed with non-deionized water for one minute and then rinsed with deionized water for one minute. Except for Sample 5, a conversion coat (or pretreatment) of an aqueous solution of Cr₂(ZrF₆)₃ in deionized water, with a Cr concentration of 120 ppm and a Zr concentration of 317 ppm, was applied to the panels for three minutes. The conversion coat was adjusted to a pH value of 4 using ammonium carbonate. The panels were then rinsed using deionized water for thirty seconds. A seal coat in accordance with an embodiment of the present invention was applied for thirty to forty-five seconds. The panels were then dried at 210-220° F. for five minutes.

In this example, the sealant's composition contained water, A-187 (epoxy functional silane), and A-1100 (aminopropyltriethoxy silane). Unless the pH is indicated as “unadjusted,” the pH of the seal coat was adjusted with formic acid. The sealants' formulas and the results of the test are listed below in Table 2:

TABLE 2

| | | | | Standard 336 |
|---|---|---|---|---|
| | | | | hour Salt |
| Sample | A-187 (%) | A-1100 (%) | pH | Spray test |
| 1 | 0.05 | | | Fail |
| 2 | 0.1 | | Unadjusted, | Fail |
| | | | 5.5-6.0 | |
| 3 | 0.25 | | | Fail |
| 4 | 5.0 | | | Fail |
| 5 | 0.1 | | | Fail |
| | (No conversion | | | |
| | coating) | | | |
| 6 | 0.1 | 0.1 | Unadjusted, | Pass |
| | | | 10 | |
| 7 (Control) | | | | Fail |

The results reveal the benefit of having at least two organo-functional silanes in the sealant's composition. Furthermore, the results support the notion that the combination of at least two organo-functional silanes, in accordance with this invention, provides better corrosion resistance than only one organo-functional silane. For example, although sample 6 contained a significantly lower concentration of organo-functional silane than sample 4, it provide better corrosion resistance under the salt spray test than sample 4.

### Example 3

Example 3 provides the results of samples treated with various formulations according to the various embodiments of the present invention, with an emphasis on including in the seal coat a surfactant, Zonyl FSN. These samples were tested under a standard salt spray test for 336 hours. The tests were performed on bare 2024 T3 aluminum panels.

The tests panels were prepared by the following process prior to testing. All of the test panels were cleaned for five minutes with a silicated alkaline cleaner (Bulk Kleen™ 737G). The alkaline cleaner was prepared at a concentration of 15 g/L and heated to 140° F. Panels were rinsed with non-deionized water for one minute and then rinsed with deionized water for one minute. A conversion coat (or pretreatment) of an aqueous solution of Cr₂(ZrF₆)₃ in deionized water, with a Cr concentration of 120 ppm and a Zr concentration of 317 ppm, was applied to the panels for three minutes. The conversion coat was adjusted to a pH value of 4 using ammonium carbonate. The panels were then rinsed using deionized water for thirty seconds. A seal coat in accordance with an embodiment of the present invention was applied for thirty to forty-five seconds. The panels were then dried at 210-220° F. for five minutes.

In this example the sealants comprised of one or more of the following: water, A-187 (epoxy functional silane), Z-6094 (aminoethylaminopropyltrimethoxy silane), and Zonyl FSN (ethoxylated nonionic fluorosurfactant). Z6094 is an aminoethylaminopropyltrimethoxysilane, available from Dow Corning. Unless the pH is indicated as “unadjusted,” the pH of the seal coat was adjusted with formic acid. The sealants' formulas and the results of the test are listed below in Table 3:

TABLE 3

| | | | | | Standard |
|---|---|---|---|---|---|
| | | | Zonyl | | 336 |
| | | | FSN | | hour Salt |
| Sample | A-187 (%) | Z-6094 (%) | (%) | pH | Spray test |
| 1 | | 0.2 | | Unadjusted | Fail |
| 2 | 0.2 | 0.2 | | Unadjusted, | Pass |
| | | | | 9.9 | |
| 3 | 0.08 | 0.32 | 0.01 | 8.0 | Pass |
| 4 | 0.13 | 0.27 | 0.01 | 7.9 | Pass |
| 5 | 0.2 | 0.2 | 0.01 | 8.1 | Pass |
| 6 | | 0.4 | 0.01 | 8.0 | Fail |
| 7 (Control) | | | | | Fail |

The results show that the tested sealants in accordance with the present invention provide substantial corrosion resistance under a 336 hour standard salt spray. The results also demonstrate that the use of at least two organo-functional silanes provides better corrosion resistance than the use of only one organo-functional silane. Notably, in sample 6, the use of only one organo-functional silane in conjunction with a fluorosurfactant failed the salt spray test.

### Example 4

Example 4 provides the results of samples treated with various formulations and processes according to various embodiments of the present invention, with an emphasis on varying the conversion coating step. These samples were tested under a standard salt spray test for 336 hours. The tests were performed on bare 2024 T3 aluminum panels.

The test panels were generally prepared according the following process. Table 4 shows how each individual sample was prepared.

Step 1—All of the test panels were cleaned for five minutes with a silicated alkaline cleaner (Bulk Kleen™ 737G). The alkaline cleaner was prepared at a concentration of 15 g/L and heated to 140° F.

Step 2—Panels were rinsed with water for one minute.

Step 3—Panels were rinsed with deionized water for one minute.

Step 4—A conversion coat as described in Table 4 below was applied. The “standard process” used a conversion coat (or pretreatment) of an aqueous solution of Cr₂(ZrF₆)₃ in deionized water, which was applied to the panels for three minutes. In particular, and unless otherwise noted in these examples, the conversion coat was a solution of Cr₂(ZrF₆)₃ in DI water, with a Cr concentration of 120 ppm and a Zr concentration of 317 ppm. The concentrations of Example 1 were used unless otherwise noted below. The conversion coat was adjusted to a pH value of 4 using ammonium carbonate. Variations to this step are shown below.

Step 5—The panels were then rinsed using deionized water for thirty seconds.

Step 6—A final seal coat according to embodiments of the present invention was applied for thirty to forty-five seconds. In this example, the sealants contained water, A-187 (epoxy functional silane) and A-1100 (aminopropyltriethoxy silane).

Step 7—The panels were then dried at 210-220° F. for five minutes.

The results of the salt spray test are listed below in Table 4:

TABLE 4

| | Salt |
|---|---|
| | Spray |
| Process Description & Seal Composition | Results |
| Step 4 of standard process modified: The pretreatment was 0.040% Zr as H₂ZrF₆ in | Fail |
| water, with the pH adjusted to 4.0 with ammonium carbonate. No seal step was | |
| done. | |
| Step 4 as in the line directly above, sealed with 0.20% A-187 + 0.20% A-1100, pH | Fail |
| adjusted to 9.0 with formic acid | |
| Step 4 of standard process modified: The pretreatment was 0.040% Zr as H₂ZrF₆ + | Fail |
| 0.014% CrF₃•4H₂O in water, with the pH adjusted to 4.0 with ammonium | |
| carbonate. No seal step was done. | |
| Step 4 as in the line directly above, sealed with 0.20% A-187 + 0.20% A-1100, pH | Pass |
| adjusted to 9.0 with formic acid | |
| Step 4 of standard process modified: The pretreatment was 0.012% Cr as | Fail |
| CrF₃•4H₂O in water, with the pH adjusted to 4.0 with ammonium carbonate. No | |
| seal was done. | |
| Step 4 as in the line directly above, sealed with 0.20% A-187 + 0.20% A-1100, pH | Fail |
| adjusted to 9.0 with formic acid | |
| Standard process, sealed with 0.20% A-187 + 0.20% A-1100, pH adjusted to 9.0 | Pass |
| with formic acid | |
| Control - no seal | Fail |

The results revealed that without a sealant, the treatment process failed to adequately provide corrosion resistance. Furthermore, sample 2 shows that the replacement of Cr₂(ZrF₆)₃ with 0.04% H₂ZrF₆ in step four results in a failure to adequately prevent corrosion under the salt spray test, even if a sealant was applied. Sample 6 also reveals that the replacement of Cr₂(ZrF₆)₃ with 0.012% Cr as CrF₃.4H₂O in step four results in a failure to adequately prevent corrosion under the salt spray test, even when a sealant was applied. However, sample 4 reveals that the replacement of Cr₂(ZrF₆)₃ in step four with the combination of 0.04% H₂ZrF₆+0.014 CrF₃.4H₂O provides substantial resistance to corrosion under a 336 hour salt spray test. Without being held to any one theory, Example 4 supports the notion that a synergistic effect occurs when a Group IV-B element, chromium (either as part of the element or added separately as a salt) and an embodiment of seal coat of the invention are used in combination.

### Example 5

Example 5 provides the results of samples treated with various formulations and processes according to the various embodiments of the present invention. These samples were tested under a standard salt spray test for 336 hours in accordance with ASTM B117. All salt spray performance ratings (pass/fail) in all of the examples were carried out in accordance with MIL-DTL-81706B. The tests were performed on bare 2024 T3 aluminum panels.

Sample 1, listed in Table 5 below, was prepared according the following process.

Step 1—This test panel was cleaned for five minutes with a silicated alkaline cleaner (Bulk Kleen™ 737G). The alkaline cleaner was prepared at 15 g/L and heated to 140° F.

Step 2—The panel was rinsed with water for one minute.

Step 3—The panel was rinsed with deionized water for one minute.

Step 4—A conversion coat of an aqueous solution of Cr₂(ZrF₆)₃ in deionized water was applied to the panel for three minutes. The concentrations of Example 1 were used. The pH of the conversion coat was adjusted to 4 using ammonium carbonate.

Step 5—The panel was then rinsed using deionized water for thirty seconds.

Step 6—An aqueous solution of 0.20% A-1100 (aminopropyltriethoxy silane) and 0.20% A-187 (epoxy functional silane) was applied for thirty to forty-five seconds. The pH of the solution was adjusted to 8.9 using formic acid.

Step 7—The panel was then dried at 210-220° F. for five minutes.

The standard process, used for sample 1, was modified to minimize aqueous reactions between the two constituents in the sealant composition. Sample 2, listed in Table 5 below, was prepared according the following process.

Step 1—The test panel was cleaned for five minutes with a silicated alkaline cleaner (Bulk Kleen™ 737G). The alkaline cleaner was prepared at 15 g/L and heated to 140° F.

Step 2—The panel was rinsed with water for one minute.

Step 3—The panel was rinsed with deionized water for one minute.

Step 4—A conversion coat of an aqueous solution of Cr₂(ZrF₆)₃ in deionized water was applied to the panel for three minutes. The concentrations of Example 1 were used. The pH of the conversion coat was adjusted to 4 using ammonium carbonate.

Step 5—The panel was then rinsed using deionized water for thirty seconds.

Step 6—An aqueous solution of 0.20% A-1100 (aminopropyltriethoxy silane) was applied for 45 seconds. The unadjusted pH of the aqueous solution was about 10.

Step 7—The panel was dried at a temperature of 210-220° F. for five minutes.

Step 8—An aqueous solution of 0.20% A-187 (epoxy functional silane) was applied for about five seconds. The unadjusted pH of the aqueous solution was about 5.

Step 9—The panels was dried at a temperature of 210-220° F. for five minutes.

The results of the salt spray test are listed below in Table 5:

TABLE 5

| | | | | | Standard |
|---|---|---|---|---|---|
| | | | | | 336 hour |
| | Altered | Length of | | | Salt Spray |
| Sample | Step | Process | Component Added | pH | test |
| 1 | Seal | | (0.2% A-187 + | 8.9 | Pass |
| | | | 0.2% A-1100) | (adjusted | |
| | | | | with formic | |
| | | | | acid) | |
| 2 | Step 6 | 45 Seconds of | 0.2% A-1100 | ≅10 | Fail (Failure |
| | | bath | | | not as severe |
| | | | | | as control) |
| | Step 7 | 5 minutes of | | | |
| | | drying at | | | |
| | | 210-220 F. | | | |
| | Step 8 | 5 Seconds of | 0.2% A-187 | ≅5 | |
| | | bath | | | |
| | Step 9 | 5 minutes of | | | |
| | | drying at | | | |
| | | 210-220 F. | | | |
| 3 | | | | | Fail |
| (Control) | | | | | |

The results support the notion that using a combination of at least two organo-functional silanes applied simultaneously provides substantial corrosion resistance. For example, the use of a combination of two or more organo-functional silanes in sample 1 resulted in substantial corrosion resistance. As seen with sample 2, however, when one organo-functional silane was applied and allowed to dry prior to to the application of a second organo-functional silane later, the sample failed to provide adequate corrosion resistance under the standard salt spray test. Without being bound to any theory, it is likely that the combination of organo-functional silanes serves to bond with, or assist in bonding among, either the other constituents in the treatment composition or the constituents of other compositions or the metal surface is itself or some combination thereof.

### Example 6

Example 6 provides the results of samples treated with various formulations and processes according to various embodiments of the present invention. This example shows that the process meets some additional requirements of MIL-DTL-81706B, which are surface resistivity and the “Wet Tape Adhesion Test” and that the process is applicable to other aluminum alloys, as described in MIL-DTL-81706B. In particular, these samples were tested under a standard salt spray test for 336 hours, a wet tape adhesion test, and surface resistivity tests (both before and after salt spray), all as described in MIL-DTL-81706B. The tests were performed on bare 2024 T3 and 6061 T6 aluminum panels.

The test panels were generally prepared according the following process. Table 6 shows how each individual sample performed under the various tests.

Step 1—All of the test panels were cleaned for five minutes with a silicated alkaline cleaner (Bulk Kleen™ 737G). The alkaline cleaner was prepared at a is concentration of 15 g/L and heated to 140° F.

Step 2—Panels were rinsed with water for one minute.

Step 3—Panels were rinsed with deionized water for one minute.

Step 4—A conversion coat of an aqueous solution of Cr₂(ZrF₆)₃ in deionized water was applied to the panels for three minutes. The concentrations of Example 1 were used unless otherwise noted below. The conversion coat was adjusted to a pH value of 4 using ammonium carbonate.

Step 5—The panels were then rinsed using deionized water for thirty seconds.

Step 6—A final seal coat of water, 0.15% A-187 (epoxy functional silane), and 0.15% A-1100 (aminopropyltriethoxy silane), with the pH adjusted to 8.9 with formic acid, was used.

Step 7—The panels were then dried at 210-220° F. for five minutes.

The results of the various tests are listed below in Table 6:

TABLE 6

| Test | 2024 T3 | 6061 T6 |
|---|---|---|
| Wet Tape Adhesion | Pass | Pass |
| Surface Resistivity, before Salt Spray | Pass | Pass |
| Surface Resistivity, after Salt Spray | Pass | Pass |
| Salt Spray Exposure | Pass | Pass |
| | (336 hours) | (168 hours) |

The data from Example 6 shows that using a combination of at least two organo-functional silanes meets the rigourous requirements of MIL-DTL-81706B. As mentioned above, pretreated panels had a primer applied to them for the Wet Tape Adhesion Test. Panels pretreated at one site were sent to a second site for testing in Example 6, and the primer was applied to the Wet Tape Adhesion test panels at the second site. In particular, this example shows that the process meets the surface resistivity and the “Wet Tape Adhesion” tests as specified, along with the salt spray test, which is shown in other examples as well.

### Example 7

Example 7 provides the results of samples treated with various formulations and processes according to various embodiments of the present invention. This example shows that the process meets the salt spray exposure test, regardless of whether the seal coat bath solution is prepared by diluting from a concentrate or if the bath solution is freshly prepared by adding the desired amount of constituents to water. The tests were performed on bare 2024 T3 aluminum panels.

The test panels were generally prepared according the following process. Table 7 shows how each individual sample was prepared.

Step 1—All of the test panels were cleaned for five minutes with a silicated alkaline cleaner (Bulk Kleen™ 737G). The alkaline cleaner was prepared at a concentration of 15 g/L and heated to 140° F.

Step 2—Panels were rinsed with water for one minute.

Step 3—Panels were rinsed with deionized water for one minute.

Step 4—A conversion coat of an aqueous solution of Cr₂(ZrF₆)₃ in deionized water was applied to the panels for three minutes. The concentrations of Example 1 were used unless otherwise noted below. The conversion coat was adjusted to a pH value of 4 using ammonium carbonate.

Step 5—The panels were then rinsed using deionized water for thirty seconds.

Step 6—The samples were treated with a final seal coat of as described below. The seal concentrate was made up of the following (all by weight percent):

DI water: 78.50%

40% Formic Acid: 1.50%

Silquest A-187: 10.00%

Ameopure A-1100: 10.00%

pH of concentrate=8.70

Step 7—The panels were then dried at 210-220° F. for five minutes.

The results of the 336 hour neutral salt spray exposure test are listed below in Table 7:

TABLE 7

| | Salt Spray |
|---|---|
| Seal Coat Description | Results |
| 2% solution of freshly prepared concentrate, pH of working | Pass |
| solution = 6.8 | |
| 2% solution of 14 day old concentrate, pH of working | Pass |
| solution = 5.6 | |
| Freshly prepared 0.20% A-187 + 0.20% A-1100, | Pass |
| pH adjusted to 8.9 with formic acid | |
| Control - no seal | Fail |

The data from Example 7 shows that using a combination of at least two organo-functional silanes meets the salt spray exposure test regardless of whether the seal coat bath solution is prepared by diluting a concentrate or if it is freshly prepared by adding the desired amount of additives directly to a seal coat bath. The second sample also shows that embodiments of the invention provide good corrosion resistance even if aged and even if the pH drops during such aging.

### Example 8

Example 8 provides the results of samples treated with various formulations and processes according to various embodiments of the present invention. This example shows that the process meets the salt spray exposure test, regardless of whether the seal coat bath solution is freshly prepared or aged. The tests were performed on bare 2024 T3 aluminum panels.

The test panels were generally prepared according the following process. Table 8 shows how each individual sample was prepared.

Step 1—All of the test panels were cleaned for five minutes with a silicated alkaline cleaner (Bulk Kleen™ 737G). The alkaline cleaner was prepared at a concentration of 15 g/L and heated to 140° F.

Step 2—Panels were rinsed with water for one minute.

Step 3—Panels were rinsed with deionized water for one minute.

Step 4—A conversion coat of an aqueous solution of Cr₂(ZrF₆)₃ in deionized water was applied to the panels for three minutes. The concentrations of Example 1 were used. The conversion coat was adjusted to a pH value of 4 using ammonium carbonate.

Step 5—The panels were then rinsed using deionized water for thirty seconds.

Step 6—The samples were treated with a final seal coat as described in Table 8 below.

Step 7—The panels were then dried at 210-220° F. for five minutes.

The results of the 336 hour neutral salt spray exposure test are listed below in Table 8:

TABLE 8

| | Salt |
|---|---|
| | Spray |
| Seal Composition (solutions in DI water) | Results |
| Freshly prepared: 0.10% A-187 + 0.10% A-1100 + | Pass |
| 0.01% Zonyl FSN, pH adjusted to 8.9 with formic acid | |
| Aged 21 days: 0.20% A-187 + 0.20% A-1100 + | Pass |
| 0.01% Zonyl FSN, pH dropped from 9.0 to 7.3 | |
| Aged 21 days: 0.40% A-187 + 0.40% A-1100 + | Pass |
| 0.015 Zonyl FSN, pH dropped from 9.0 to 7.1 | |
| Freshly prepared: 0.20% A-187 + 0.20% A-1100 + | Pass |
| 0.01% Zonyl FSN, pH adjusted to 8.9 with formic acid | |
| Control - no seal | Fail |

The data from Example 8 shows that using a combination of at least two organo-functional silanes meets the salt spray exposure test regardless of whether the seal coat bath solution is freshly prepared or is aged. In particular, the second and third samples show that embodiments of the invention provide good corrosion resistance even if aged 21 days and even if the pH drops during such aging.

### Example 9

Example 9 provides the results of samples treated with various formulations and processes according to various embodiments of the present invention. This example shows that the process meets the salt spray exposure test, even under different drying conditions of the seal coat. The tests were performed on bare 2024 T3 aluminum panels.

The test panels were generally prepared according the following process. Table 9 shows how each individual sample was prepared.

Step 1—All of the test panels were cleaned for five minutes with a silicated alkaline cleaner (Bulk Kleen™ 737G). The alkaline cleaner was prepared at a concentration of 15 g/L and heated to 140° F.

Step 2—Panels were rinsed with water for one minute.

Step 3—Panels were rinsed with deionized water for one minute.

Step 4—A conversion coat of an aqueous solution of Cr₂(ZrF₆)₃ in deionized water was applied to the panels for three minutes. The concentrations of Example 1 were used. The conversion coat was adjusted to a pH value of 4 using ammonium carbonate.

Step 5—The panels were then rinsed using deionized water for thirty seconds.

Step 6—The samples were treated with a final seal coat as described in Table 9 below.

Step 7—The panels were then dried under the varying conditions specified in Table 9 below.

The results of the 336 hour neutral salt spray exposure test are listed below in Table 9:

TABLE 9

| | Salt |
|---|---|
| | Spray |
| Seal Composition and Process Description | Results |
| 0.20% A-187 + 0.20% A-1100, pH adjusted to 8.9 with formic | Pass |
| acid, standard dry off (5 min @ 210-220° F.) | |
| Seal as above, 5 min @ 150° F. dry off | Pass |
| Seal as above, overnight dry off @ ambient | Pass |
| Control - no seal | Fail |

The data from Example 9 shows that using a combination of at least two organo-functional silanes meets the salt spray exposure test over a range of drying conditions of the seal coat. In particular, the second and third samples show that embodiments of the invention provide good corrosion resistance even if the temperature is reduced, even to ambient, during the drying step.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. An aqueous sealing composition for sealing a pretreated metal surface, said composition comprising water and at least two organo-functional silanes, wherein the composition has a pH of at least 5.5.

2. The aqueous sealing composition of claim 1, wherein the composition has a pH of at least 6 and less than or equal to 10.

3. The aqueous sealing composition of claim 1, wherein the composition has a pH of at least 7 and less than or equal to 9.

4. The aqueous sealing composition of claim 1, wherein the at least two organo-functional silanes are selected from the group consisting of epoxy functional silane, gamma-glycidoxypropyltrimethoxy silane, aminopropyltriethoxy silane, and aminoethylaminopropyltrimethoxy silane.

5. The aqueous sealing composition of claim 1, wherein the at least two organo-functional silanes comprise at least one epoxy functional silane and at least one amino functional silane.

6. The aqueous sealing composition of claim 5, wherein the epoxy functional silane is present in the amount of at least 0.05% weight/vol.

7. The aqueous sealing composition of claim 5, wherein the aminopropyltriethoxy silane is present in the amount of at least 0.05% weight/vol.

8. The aqueous sealing composition of claim 5, wherein the epoxy functional silane is present in the amount of at least 0.05% weight/vol. and the aminopropyltriethoxy silane is present in the amount of at least 0.1% weight/vol.

9. The aqueous sealing composition of claim 5, wherein the epoxy functional silane is present in the amount of at least 0.1% weight/vol. and the aminopropyltriethoxy silane is present in the amount of at least 0.1% weight/vol.

10. The aqueous sealing composition of claim 1, further comprising a surfactant.

11. The aqueous sealing composition of claim 1 further comprising formic acid to adjust the pH.

12. A process for treating a metal surface, said process comprising the steps of:
cleaning the metal surface;
contacting the metal surface with an aqueous pretreatment composition comprising water and a compound of a Group IV-B element; and
contacting the metal surface with an aqueous sealing composition for sealing a pretreated metal surface comprising water and at least two organo-functional silanes, wherein the composition has a pH of at least 5.5.

13. The process of claim 12 further comprising, before the step of contacting the metal surface with the aqueous pretreatment composition:
rinsing the metal surface.

14. The process of claim 12, wherein the rinsing step comprises:
rinsing the metal surface with water for about at least 15 seconds; and
rinsing the metal surface with de-ionized water for about at least 15 seconds minute.

15. The process of claim 12 further comprising, after the step of contacting the metal surface with the aqueous pretreatment composition:
rinsing the metal surface; and
drying the metal surface.

16. The process of claim 12 wherein the cleaning step comprises cleaning the metal surface with a silicated alkaline cleaner.

17. The process of claim 14, wherein the rinsing steps and the contacting steps are conducted at ambient conditions.

18. The process of claim 12, wherein the at least two organo-functional silanes are selected from the group consisting of epoxy functional silane, gamma-glycidoxypropyltrimethoxy silane, aminopropyltriethoxy silane, and aminopropyltriethoxy silane.

19. The process of claim 18, wherein the at least two organo-functional silanes are epoxy functional silane and aminopropyltriethoxy silane.

20. The process of claim 19, wherein the epoxy functional silane is present in the amount of at least 0.05% weight/vol.

21. The process of claim 19, wherein the aminopropyltriethoxy silane is present in the amount of at least 0.05% weight/vol.

22. The process of claim 19, wherein the epoxy functional silane is present in the amount of at least 0.05% weight/vol. and the aminopropyltriethoxy silane is present in the amount of at least 0.05% weight/vol.

23. The process of claim 19, wherein the epoxy functional silane is present in the amount of at least 0.1% weight/vol and the aminopropyltriethoxy silane is present in the amount of at least 0.1% weight/vol.

24. The process of claim 12, wherein the aqueous sealing composition further comprises a surfactant.

25. The process of claim 12, wherein the aqueous sealing composition has a pH of less than or equal to 10.

26. The process of claim 12, wherein the compound of the Group IV-B element comprises chromium fluozirconate.

27. The process of claim 12, wherein Group IV-B element comprises a fluozirconic acid and the pretreatment composition further comprises a chromium salt.
